(19) United States
(12) Patent Application Publication
(10) Pub. No.: US 2026/0320417 A1
(43) Pub. Date: Oct. 15, 2026

(54) SYSTEM AND METHOD FOR TEMPORAL ALIGNMENT EVALUATION, DRIFT DETECTION, AND AUDIT-READY GOVERNANCE OF INTELLIGENT SYSTEMS

(71) Applicant: Michel Donald Moore, flemington, NJ (US)

(72) Inventor: Michel Donald Moore, Flemington, NJ (US)

(21) Appl. No.: 19/445,554

(22) Filed: Jan. 11, 2026

(51) Int. Cl. G06N 5/02

(52) U.S. Cl. CPC G06N 5/02

(57) ABSTRACT

The Harmonic Alignment System (HAS) is a system-level framework for evaluating and governing alignment of intelligent systems over time. The system provides a repeatable evaluation loop that receives observable system behavior and contextual indicators, generates structured alignment states, and compares such states longitudinally to detect changes or drift. HAS produces audit-ready records with traceable provenance describing evaluation context, observed indicators, alignment outputs, and temporal comparisons. The system supports human-in-the-loop participation through defined checkpoints while maintaining separation between evaluation and behavioral control. HAS operates independently of specific model architectures, training methods, or infrastructures and may optionally support external verification of alignment records. The system enables temporal alignment assessment, drift awareness, and governance signaling across the lifecycle of intelligent systems.

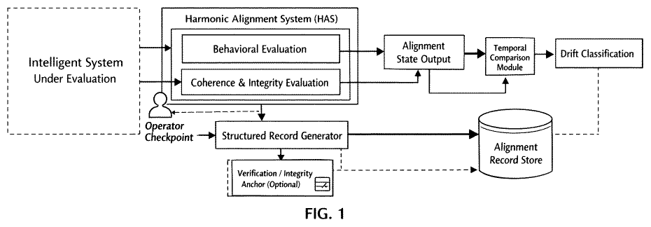

### FIELD OF THE INVENTION

The present invention relates generally to artificial intelligence and intelligent systems and, more particularly, to systems and methods for evaluating, monitoring, and governing alignment, coherence, and stability of intelligent systems over time.

The invention pertains to alignment evaluation frameworks that provide repeatable, longitudinal assessment of intelligent system behavior, including mechanisms for detecting drift, preserving evaluation records, and enabling human-in-the-loop governance without requiring control over the internal architecture or operation of the evaluated system.

### BACKGROUND OF THE INVENTION

Contemporary intelligent systems are commonly evaluated for alignment, safety, or correctness using point-in-time tests, static benchmarks, or isolated performance metrics. While such approaches may provide useful snapshots, they do not adequately account for temporal behavior, including how alignment properties change as systems are updated, fine-tuned, deployed in new contexts, or operated over extended periods.

As a result, intelligent systems may appear aligned at one moment while experiencing undetected drift, degradation, or internal inconsistency at later stages of deployment. Existing approaches typically lack structured mechanisms for comparing alignment states across time, versions, or operating conditions in a repeatable and auditable manner.

In many cases, alignment evaluation is decoupled from traceable governance. Systems often fail to preserve structured records describing how alignment conclusions were reached, what evaluation conditions applied, or whether human oversight occurred. This lack of traceability hinders auditing, accountability, and independent review.

Additionally, existing frameworks frequently conflate measurement of alignment with control or enforcement, embedding behavioral modification or constraint logic into evaluation processes. This conflation creates ambiguity as to whether alignment indicators represent observations or imposed judgments, complicating governance and oversight.

Accordingly, there exists a need for a system-level framework that treats alignment as a dynamic, observable property; supports repeatable evaluation over time; enables longitudinal comparison and drift detection; produces audit-ready records; and facilitates human oversight without requiring control over the evaluated system.

### SUMMARY OF THE INVENTION

The Harmonic Alignment System (HAS) is a system-level framework for defining, measuring, and stabilizing alignment of intelligent systems over time.

HAS treats alignment as a temporal property that may change, drift, degrade, or recover rather than as a single point-in-time condition. The system provides a repeatable evaluation loop that converts observable system behavior, contextual conditions, and coherence indicators into a structured alignment state.

HAS produces alignment outputs designed to be comparable across evaluation sessions, system versions, and deployment contexts, enabling longitudinal oversight and drift awareness. The system further generates structured records capturing evaluation context, indicators, outputs, temporal comparisons, and human participation, thereby enabling auditability and traceable governance.

The system supports operator participation through defined checkpoints for intent specification, review, and confirmation while maintaining a strict separation between evaluation and control. HAS does not require access to proprietary model internals, training data, or source code and does not depend on any specific artificial intelligence architecture, provider, or infrastructure.

Through these features, HAS provides a unified framework for temporal alignment evaluation, drift detection, and audit-ready governance across the lifecycle of intelligent systems.

### DETAILED DESCRIPTION OF THE INVENTION

### 1. System Overview

In operation, the Harmonic Alignment System interfaces with an intelligent system under evaluation by receiving observable outputs, contextual signals, and defined evaluation conditions associated with system operation. The intelligent system may comprise any artificial intelligence model, agent, or composite system and need not expose internal parameters, training data, or source code to HAS.

HAS operates as a closed evaluation and record-generation framework that functions alongside the evaluated system. No enforcement, control, or action path is provided from HAS back into the intelligent system.

### 2. Core Evaluation Loop

HAS comprises a repeatable evaluation loop that may be executed episodically, continuously, or in response to defined triggering events. The evaluation loop includes:
1. Input Acquisition, in which observable outputs, contextual conditions, and evaluation parameters are received;
2. Evaluation Processing, in which alignment-relevant indicators are assessed;
3. Alignment State Generation, producing a structured representation of observed alignment, coherence, and stability;
4. Temporal Comparison, in which current alignment states are compared with previously recorded states; and
5. Record Generation, capturing evaluation context, indicators, outputs, comparisons, and participation metadata.

This loop structure remains consistent across evaluation sessions to enable comparability and longitudinal analysis.

### 3. Behavioral and Coherence Evaluation

HAS distinguishes between multiple categories of alignment evidence assessed in parallel, including:
Behavioral evaluation, which considers observable system responses, outputs, or performance signals; and
Coherence and integrity evaluation, which considers internal consistency, stability, contradiction pressure, or reasoning continuity as observable indicators.

This separation allows alignment to be assessed beyond surface-level correctness and enables detection of subtle degradation over time.

### 4. Operator Participation and Checkpoints

HAS incorporates defined operator participation points that allow human intent specification, review, confirmation, or contextual framing to be incorporated into the evaluation process.

Operator participation informs evaluation scope and interpretation but does not modify, constrain, or control operation of the intelligent system. Dashed or side-channel interfaces may be used to visually or logically indicate participation without authority or enforcement.

### 5. Alignment State Output

For each evaluation cycle, HAS produces an alignment state output representing observed alignment characteristics at a given point in time. Alignment states are structured to be portable, reviewable, and comparable across sessions, contexts, and system versions.

### 6. Temporal Comparison and Drift Detection

HAS compares alignment states across time to identify changes, trends, or deviations. Detected changes may be classified according to characteristics such as severity, persistence, or temporal pattern, enabling differentiation between gradual drift and abrupt instability.

Drift detection operates on recorded alignment states and does not require direct interaction with the evaluated system.

### 7. Record Generation and Storage

For each evaluation cycle, HAS generates a structured record preserving:
evaluation context and conditions;
observed inputs and indicators;
alignment state outputs;
temporal comparison results; and
operator participation metadata.

Records are stored in an alignment record store designed to preserve traceability and comparability across time, deployments, and versions.

### 8. Optional Verification and Integrity Anchoring

In some embodiments, alignment records may be anchored to an external verification or integrity substrate, such as a distributed ledger or immutable data store, to support independent verification or timestamping.

Such anchoring is optional and does not alter core HAS operation or impose infrastructure dependencies.

### 9. System Boundary and Non-Control Constraint

HAS explicitly separates alignment evaluation from enforcement or behavioral control. The system does not prescribe actions, mandates, sanctions, or system modifications based on alignment outcomes.

Any action taken in response to HAS outputs occurs externally and is not part of the HAS system itself.

### 10. Non-Limiting Embodiments

HAS may be embodied in various non-limiting forms, including:
evaluation engines analyzing reasoning traces or coherence indicators;
operating environments supporting continuous or episodic monitoring;
audit and certification workflows generating structured alignment summaries;
governance or oversight frameworks using HAS outputs for review or policy consideration; and
optional verification layers enabling independent record validation.

All embodiments are illustrative and do not alter or supersede the core definition of the Harmonic Alignment System.

1. A system for temporal alignment evaluation and governance of an intelligent system, the system comprising:
(a) an input interface configured to receive observable outputs of the intelligent system and evaluation context data;
(b) an evaluation module configured to assess the received outputs according to predefined alignment and coherence criteria;
(c) an alignment state generator configured to produce a structured alignment state representing observed alignment characteristics of the intelligent system at a given time;
(d) a temporal comparison module configured to compare the alignment state with one or more previously generated alignment states to identify changes over time;
(e) a drift detection module configured to identify alignment drift based on the temporal comparison; and
(f) a record generation module configured to generate and store a structured evaluation record comprising the alignment state, temporal comparison results, and associated evaluation context, wherein the system evaluates alignment as a temporal property without requiring control over the intelligent system.

2. A system for audit-ready governance of intelligent systems, comprising:
(a) a repeatable evaluation loop configured to process observable behavior of an intelligent system;
(b) an alignment assessment component configured to generate alignment indicators during each evaluation cycle;
(c) a longitudinal analysis component configured to evaluate changes in the alignment indicators across multiple evaluation cycles;
(d) a structured record store configured to preserve alignment indicators and longitudinal analysis results in a traceable manner; and
(e) an operator interface configured to permit human participation in defining evaluation intent or reviewing evaluation outcomes, wherein the system produces alignment records suitable for longitudinal review without enforcing behavioral control on the intelligent system.

3. The system of claim 1, wherein the evaluation module operates as a repeatable evaluation loop comprising input acquisition, assessment, alignment state generation, temporal comparison, and record generation.

4. The system of claim 1, wherein the evaluation module assesses alignment using both behavioral performance evidence and coherence or integrity evidence.

5. The system of claim 2, wherein the operator interface permits intent specification, review, or confirmation without modifying operation of the intelligent system.

6. The system of claim 1, wherein the drift detection module classifies detected drift based on severity, persistence, or temporal pattern.

7. The system of claim 6, wherein drift is classified as gradual drift or abrupt drift based on alignment state divergence over time.

8. The system of claim 1, wherein the structured evaluation record preserves evaluation context, alignment state, temporal comparison data, and operator participation data.

9. The system of claim 2, wherein the structured record store enables independent review of alignment records across system versions, deployment contexts, or time periods.

10. The system of claim 1, wherein the system operates independently of any specific artificial intelligence model architecture, training method, or infrastructure.

11. The system of claim 1, wherein the structured evaluation record is optionally anchored to an external integrity or verification substrate.

12. The system of claim 1, wherein the evaluation loop operates episodically, continuously, or in response to defined triggering events.

13. The system of claim 2, wherein longitudinal analysis supports governance of alignment across deployment, update, and operational lifecycle phases.

14. The system of claim 1, wherein the evaluation module is implemented using one or more software components, auxiliary evaluators, or monitoring processes.

15. The system of claim 2, wherein the system explicitly separates alignment evaluation from enforcement or behavioral control actions.
